(19) United States
(12) Patent Application Publication
(10) Pub. No.: US 2015/0350289 A1
(43) Pub. Date: Dec. 3, 2015

(54) Methods & Systems for Transmission of High Resolution & Low Latency Data

(71) Applicant: Paladin Innovators, Federal Way, WA (US)

(72) Inventors: Jonathan Clem, Seattle, WA (US); Dean Bisogno, Fort Collins, CO (US)

(21) Appl. No.: 14/291,371

(22) Filed: May 30, 2014

(51) Int. Cl. H04L 29/06; H04L 12/841; H04L 12/803; H04N 19/10; H04N 21/236

(52) U.S. Cl. CPC H04L 65/80; H04N 19/10; H04N 21/236; H04L 47/122; H04L 47/28

(57) ABSTRACT

Methods and systems for transmission of high resolution and low latency data are disclosed herein. The essential practice of these methods and systems is the design of systems which prioritize delivering the video stream from point to point in the shortest amount of time possible by adaptively compensating for bandwidth limitations, compressing each frame in real time, and pushing the frames to the client over a full duplex socket.

### Priority Claim

The present application claims priority from and the benefit of U.S. Provisional Application No. 61/828,795 filed on May 30, 2013 which is herein incorporated by reference.

### DETAILED DESCRIPTION OF THE PREFERRED EMBODIMENT

### General Field and Type of Invention

Video production is the primary field in which the invention can be applied, though it could be applied to any situation in which high definition data frames must be transmitted with minimal error and low latency. The invention is instantiated by implementing the methods and systems outlined in the invention.

### Commercial Applications

Product which would use the invention would require high quality, near instantaneous feeds of video from any number of sources to be transmitted over a standard computer network. A wireless camera monitor for mobile devices is an example of this.

### Purpose of the Invention

The purpose of the invention is to provide near-real time (latency of less than 250 milliseconds). Rather than viewing video feeds on hardwired monitors, users could have similar experiences on a mobile device attached to their network.

### Previous Approaches to Accomplish the Same Purpose as this Invention, and Their Limitations

Other systems which transmit video often have to prioritize quality or bandwidth utilization. In prioritizing quality, many algorithms inspect smaller areas to reduce the chance of artifacting and in order to catch finer edge detail. Prioritization of bandwidth utilizes higher compression algorithms. Both of these approaches negatively affect the latency of the data stream.

Latency is also introduced into most video streaming systems via their transport and delivery mechanisms. Rarely is video broadcast in a point-to-point configuration, and the introduction of a Content Distribution Network (CDN) adds several seconds of delay as data propagates out to edge nodes.

Protocols like Adobe's Real Time Messaging Protocol (RTMP) require proprietary plugins and implement Digital Rights Management (DRM) systems which add their own time to the latency of data streams.

### DETAILED DESCRIPTION OF THE INVENTION

Ultra Low Latency Streaming (ULLS) provides a method for streaming live video content to a mobile device, desktop software application, or web browser in applications where the lowest possible latency is required.

Current video streaming technologies utilize codecs typically optimized for either, A) Bandwidth (the size of the video stream measured in bits per second) or, B) Image quality (either measured objectively in terms of number of pixels or subjectively in terms of how the image looks to the viewer).

ULLS prioritizes delivering the video stream from point to point in the shortest amount of time possible by adaptively compensating for bandwidth limitations, compressing each frame in real time, and pushing the frames to the client over a full duplex socket.

ULLS Signal Processing Flow is 1) The server creates a highly compressed frame from the live video source, 2) The server sends the frame to client over a full-duplex secure socket, with time stamp included in packet , 3) The client renders the frame, marking the difference between current time and time stamp on frame, 4) The client sends the time stamp difference to the server asynchronously over the open socket, 5) The server decreases compression level and increases the video frame rate, as long as doing so does not impact latency, 6) When latency spikes, the server starts over with another highly compressed frame, re-establishing the compression baseline

Existing streaming video standards such as RTSP/RTMP and MMS require a plugin or third party player (such as Adobe Flash) making compatibility on mobile devices such as the iPhone/iPad impossible. Existing solutions for mobile compatibility such as Apple's HTTP Live Streaming, Microsoft Smooth Streaming and Adobe HDS solve the problem of compatibility on mobile devices by using HTTP as the transport mechanism, but in doing so introduce latency of a minimum of 1 second, and typically closer to 10 seconds, even in best case bandwidth/latency scenarios.

Ultra low latency streaming uses universally supported transport mechanisms (either WebSockets or TCP/UDP) but requires no proprietary plugins, streaming the video data to the mobile client as raw base 64 data packets which are then reconstructed on the client to produce video with latencies under 100 ms for 1080 p HD video. When using 24 frame per second video as the source stream, 100 ms equates to roughly two frame delay, producing latency levels over WiFi connections that are unmatched by existing live streaming technologies and enabling applications such as live video mixing for television/IPTV broadcast from a mobile device, such as an Apple iPad.

### PREFERRED EMBODIMENTS OF THIS INVENTION

Instantiations of the invention are most likely to appear in situations where near real-time high quality data streams are required. Video systems are a prime market in which modern network bandwidth capacities allow for better video than what current transport methods allow. Rather than requiring a hardware monitor directly attached to a camera or switch board, users can view similar quality video on their mobile devices.

Other embodiments could move dense medical diagnostic data to be shared between geographically disparate doctors.

1. Transport packaging for high quality, low latency data transmission.

2. Usage of frame enumeration as a method for synchronizing video on server and client.

3. Producer/Consumer model used to optimize data latency over network.

4. Dynamic latency management via packet timestamps allowing for active adjustment of data stream latency.

5. High quality data streaming with transport layer plugins.
